(19) United States
(12) Patent Application Publication
(10) Pub. No.: US 2008/0200572 A1
(43) Pub. Date: Aug. 21, 2008

(54) Process For The Production of Extruded Sheets Of Expanded Polystyrene

(75) Inventors: Walter Movilli, Reggio Emilia (IT); Federico Lanzani, Reggio Emilia (IT)

Correspondence Address: LUCAS & MERCANTI, LLP, 475 PARK AVENUE SOUTH, 15TH FLOOR, NEW YORK, NY, 10016, US

(73) Assignee: COOPBOX EUROPE S.P.A., Reggio Emilia (IT)

(21) Appl. No.: 11/915,972

(22) PCT Filed: May 29, 2006
(86) PCT No.: PCT/EP06/05102

§ 371 Date: Jan. 22, 2008

(30) Foreign Application Priority Data
Jun. 3, 2005 (IT) MO2005A000135

(51) Int. Cl. C08J 9/228

(52) U.S. Cl. 521/81

(57) ABSTRACT

A process for the production of extruded sheets of expanded polystyrene, which only uses expanding agents with low environmental impact, comprising the steps of: a) heating polystyrene or a mixture composed of polystyrene and at least one component selected from the group consisting flame retardants, coloring agents, plasticizers, heat stabilizers and lubricants at a temperature in the range of 180-2500 C thus obtaining a polymer melt, which is subjected to homogenization; b) adding to the polymer melt a mixture of expanding agents comprising carbon dioxide and water; c) homogenizing the polymer melt including said expanding agents; d) homogeneously cooling the polymer melt to a temperature lower than or equal to 1400 C; e) extruding the cooled polymer melt through a die to obtain an expanded polystyrene sheet.

### FIELD OF APPLICATION

In its most general aspect, the present invention refers to a process for the production of extruded expanded polystyrene.

More in particular, the invention refers to a process of the aforesaid type wherein the expanded polystyrene is extruded in the form of sheets which are particularly but not exclusively suitable for use as panels for heat insulation.

### PRIOR ART

Expanded polystyrene is a polymer with porous structure, light and with a low thermal conductivity, as has been known for several decades. In these years, the production of this polymer has consistently increased, also boosted by the increase of its possible applications.

It is known, in fact, that expanded polystyrene is largely employed as insulating material in industry and in construction, as a floating material in boating or in the making of insulating packing and packages.

For it to be considered a good material, in consideration of the use for which it is intended, the expanded polystyrene must have particular characteristics, such as for example density, distribution and average size of the porous structure cells which must always fall within specific ranges of values.

It is known that expanded polystyrene was initially obtained by means of easily run processes, in which chlorofluorocarbons (CFCs) were employed as expanding agents.

Following the discovery, at the beginning of the 1990s, that the CFCs were among the main causes of the reduction of the ozone layer in the stratosphere, such substances were prohibited and replaced by the hydrochlorofluorocarbons (HCFCs). Later on, the latter were prohibited too and finally replaced by the hydrofluorocarbons (HFCs).

Even if they are environmentally more compatible and allowed by current laws, such substances also cause atmospheric pollution problems, and their cost is rather high.

Recently, the prior art has made available processes in which the expanding agent is represented by carbon dioxide (CO₂), i.e. an atmospheric gas, which is thus less damaging for the environment.

Nevertheless, since CO₂ by itself is sparingly soluble in the polystyrene and therefore cannot be used in a sufficient percentage to attain low densities, it is generally used in mixtures with alcohols and ketones, or it is used in only partial substitution of the conventional expanding agents.

Typically, the desired density of the expanded polystyrene for use as insulating material is in the range of 28-34 kg/m³. With too high a density, as it is obtained in fact if only CO₂ is used as expanding agent, there is also an excessive production cost of the expanded polystyrene.

It remains of great interest, and is the object of continuous research, to establish extrusion processes for the production of polystyrene expansions in which expanding substances may be employed that have little or no environmental impact, in addition to being economically competitive.

The U.S. Pat. No. 4,436,679 describes, for example, a method for the production of extruded expanded polystyrene sheets for the thermoforming of trays, in which the expanding mixture comprises water and one or more components selected from among CO₂, nitrogen, air and azodicarbonamide.

The expanded polystyrene obtained with such a method, limited to the capacity of 55 kg/h with small laboratory extruders, has a density in the range of 36.8-336 kg/m³.

The above method foresees a separate feeding of the expanding agents in different steps and sections of the extrusion apparatus.

In particular, water is introduced upstream with respect to the site of CO₂ introduction, directly into the plasticizing cylinder of the extrusion device, while CO₂ and other possibly used gaseous expanding agents, such as nitrogen and air, are subsequently dispersed in the melted plastic mass.

The metering of such gaseous expanding agents is controlled by an injection and dispersion device which foresees the passage of the gas through two surfaces in close contact with each other, one of which surfaces being made rough by means of sandblasting, thus permitting the flow of the gas at pressures higher than 280 bars.

The feeding of the gaseous expanding agents occurs at the end of the plasticising cylinder, if a single extruder is foreseen, or between a primary and a secondary extruder, if the extrusion apparatus is of the so-called tandem type.

In case chemical expanding agents such as azodicarbonamide are also employed, these are introduced into the loading hopper and fed together with the polystyrene beads.

While advantageous in several aspects, this method presents various drawbacks, including a limited production capacity, since it is actuated by means of small laboratory extruders, which moreover permit obtaining expanded polystyrene with rather a high density.

Moreover, it is difficult to keep a constant metering of the various gaseous expanding agents, since the metering is entrusted to a rather complex device, which operates based on a pressure difference that is difficult to control.

A second example of a production method of expanded thermoplastics using expanding agents with low environmental impact is described in patent EP 637 329.

Such a patent describes the production of sheets of expanded styrene resins for the thermoforming of trays, in which water and CO₂ are employed as expanding agents together with a nucleating agent, the latter being in a quantity in the range of 0.005-1.0% based on the weight of the styrene polymer.

In particular, the styrene resin sheets are obtained with a density in the range of 32-160 kg/m³ by means of extrusion through an annular die at a temperature not higher than 150° C. (42.4 kg/m³ is the minimum density reported in the examples, while 48 kg/m³ is the lower limit of the preferred density range).

Water (endothermic agent) is used in a quantity in the range of 1-30% based on the total weight of CO₂, with the object of obtaining a thermoplastic foam with higher density and lower corrugation over the one obtained with use of only CO₂.

Although advantageous under various aspects, this method is limited by the fact that the obtained thermoplastic foam has in any case a high density, and its use is consequently limited.

A further example of expanded thermoplastics obtained by means of the use of low environmental impact expanding agents is described in patent EP 887 167.

Such a patent describes a process for producing extruded expanded polymers on small laboratory facilities, wherein a first expanding agent, for example CO₂, is mixed and incorporated in the melted plastic material in order to form an expandable gel.

A second expanding agent containing water is then admixed and incorporated into the obtained gel, which has been cooled to a temperature below 160° C.; then, after an optional additional cooling, the gel is extruded through the die.

While fulfilling the object, this latter process also shows drawbacks, since it is limited to an application on small facilities characterized by poor productivity (the maximum reported in the examples is 5.6 kg/h). The incorporation of water into the already cooled gel, moreover, requires a particularly active homogenizing action and a consequent high energy consumption.

It would be desirable therefore to provide a process for producing sheets and panels of extruded polystyrene which exclusively foresees the use of expanding agents with little or no environmental impact and which permits obtaining such expanded polymer with a density even considerably lower than 40 kg/m³.

A similar process should moreover ensure high efficiency, even in facilities with productivity higher than 700 kg/h, while being at the same time economically competitive.

Finally, it should permit obtaining a polystyrene extruded expanded sheet of high quality, in particular with a uniform size and distribution of the cells of the porous structure.

### SUMMARY OF THE INVENTION

The technical problem underlying the present invention was that of making available a process for the production of an extruded expanded polystyrene sheet having the abovementioned characteristics and capable of overcoming the drawbacks highlighted above with reference to the prior art.

Such a problem has been solved, according to the invention, by a process for the production of extruded expanded polystyrene sheets particularly suitable for use in heat insulation, comprising the steps of:

a) heating polystyrene or a mixture consisting of polystyrene and at least one component selected from the group composed of flame retardants, coloring agents, plasticizers, heat stabilizers and lubricants at a temperature in the range of 180-250° C., thus obtaining a polymer melt, which is subjected to homogenization;
b) adding to said polymer melt a mixture of expanding agents comprising carbon dioxide and water;
c) homogenizing said polymer melt including said expanding agents;
d) homogeneously cooling said polymer melt to a temperature lower than or equal to 140° C.;
e) extruding said cooled polymer melt through a die to obtain an expanded polystyrene sheet.

Conveniently, said extruded expanded polystyrene sheet is converted, by means of a calibrator, into a panel of desired size and shape.

Regarding the composition of the expanding agent mixture, it contains carbon dioxide in quantities comprised between 1 and 6%, based on the weight of the polystyrene. It contains water in quantities comprised between 5 and 20%, based on the weight of the carbon dioxide, preferably between 7 and 14%.

The quantity of water based on the quantity of polystyrene is instead in the range of 0.05-1%, preferably 0.05-0.85%.

Advantageously, the extruded expanded polystyrene obtained has a density in the range of 28-40 kg/m³, and includes cells with size lower than or equal to 0.25 mm.

Preferably, the process is conducted in a tandem extruder, by carrying out the aforesaid steps from a) to c) in a plasticizing cylinder and the steps d) and e) in an extrusion cylinder (secondary extruder) placed in series with the plasticizing cylinder.

Advantageously, the polymer melt incorporating the expanding agents is pre-cooled at a temperature in the range of 190-210° C., before being transferred into the extruder cylinder.

Preferably, the mixture of expanding agents is added to the polymer melt by injection of carbon hydroxide and water in several points of the plasticizing cylinder.

Also advantageously, carbon dioxide and water may be injected together into the plasticizing cylinder, although the use of separate injectors for introducing them into the polymer melt is not excluded.

Advantageously, the process according to the invention may also be carried out in industrial plants with a productivity greater than 700 kg/h, without this resulting in a decrease of the production capacity of the plant and in an alteration of the density and size of the cells of the obtained expanded polystyrene.

Such characteristics are maintained both when the plasticizing cylinder is fed with only virgin polystyrene granules and when it is also fed with regenerated polystyrene granules.

Regarding the aforesaid components, it should be said that the flame retardants optionally included in the mixture, which are of the type typically used in the prior art, are preferably in master batch form.

Other agents such as coloring agents, plasticizers, heat stabilizers, lubricants and similar additives normally employed in the prior art to confer particular properties to the obtained polymer may be present as such or in master batch form.

Advantageously, the process according to the present invention does not involve the addition of nucleating agents to the polystyrene to be subjected to extrusion.

The use of nucleating agents in processes of the type herein considered is not particularly desirable, mainly because they are in the form of fine powders, which are particularly difficult to handle.

Further characteristics and advantages of the process according to the present invention will be more evident from the following description of one of its preferred embodiments, with reference to the attached drawing, provided for the purpose of illustration and not of limitation.

### BRIEF DESCRIPTION OF THE DRAWINGS

In the drawing:

FIG. 1 shows a schematic representation of a preferred embodiment of an extrusion apparatus for carrying out the process according to the present invention.

### DETAILED DESCRIPTION

The process steps described below do not form a complete process flow for the preparation of panels (sheets) of extruded expanded polystyrene. The present invention may be put into practice along with the preparation techniques of extruded expanded polymeric material products presently in use in the field, and only those process steps necessary for the comprehension of the invention are included in the description.

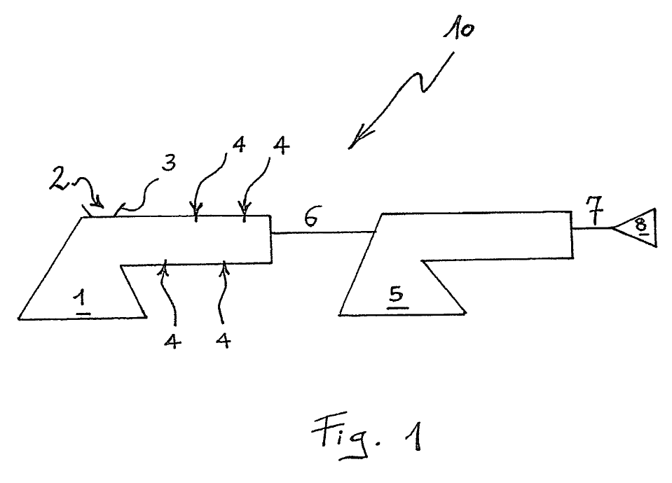

With reference to FIG. 1, a process for the production of extruded expanded polystyrene according to the present invention is schematically illustrated.

In particular, in such a process, the expanded polystyrene is extruded in sheet form, and is obtained with a density in the range of 28-40 kg/m³ and with a cell size lower than or equal to 0.25 mm; therefore, the panels made from such sheets are particularly well-suited to be used for heat insulation, both in the industrial field and the construction field, as will be clearer in the following description.

To obtain extruded panels of expanded polystyrene having the aforesaid characteristics, a mixture 2 of thermoplastic material comprising polystyrene granules is first fed to a plasticizing cylinder 1 (primary extruder).

The mixture 2 is fed to the plasticizing cylinder 1 by means of a loading hopper 3, which is in turn loaded by means of a feeding and metering device of known type (not illustrated in the FIGURE).

The mixture 2 is then heated in the plasticizing cylinder 1 to a temperature in the range of 180-250° C., generating a fluid plastic mass or polymer melt, made homogenous by means of mixing.

At this point, an expanding agent mixture 4 is added to the polymer melt; the expanding agents 4 comprise carbon dioxide (CO₂) and water.

The mixture of expanding agents 4 is added to the polymer melt by injecting carbon dioxide and water in several points of the plasticizing cylinder 1, preferably by means of the same injectors (in the example of the FIGURE, there are four injection points).

The polymer melt including such expanding agents is then made homogenous by mixing before being cooled to a temperature lower than or equal to 140° C.

Preferably, the cooling of the polymer melt incorporating the expanding agents occurs in a second extrusion cylinder 5 arranged in (cascade) series with respect to the plasticizing cylinder 1, with which it constitutes an apparatus or plant of the so-called tandem extrusion type, collectively indicated with 10.

Preferably, the polymer melt incorporating the expanding agents is pre-cooled in the plasticizing cylinder 1 to a temperature in the range of 190-210° C., before being transferred to the extrusion cylinder 5.

In the extrusion cylinder 5 or secondary extruder, the polymer melt incorporating the expanding agents 6 coming from the plasticizing cylinder 1 is cooled so as to obtain a homogeneous temperature inside the melted plastic mass, in particular near the final section of the secondary extruder 5.

For such a purpose, the secondary extruder 5 is equipped with a screw (not illustrated) capable of exerting a strong mixing action without triggering localized overheating.

Then the homogeneously cooled polymer melt 7 is extruded through a die 8 for expanded sheets of the type known in the prior art.

Thus an extruded sheet of expanded polystyrene is obtained upon exiting the die 8, which has the previously highlighted characteristics. The sheet may be shaped into the desired size and form by means of a calibrator of the type normally employed in the prior art, not represented in the FIGURE.

Regarding the mixture of the expanding agents, the percentages of carbon dioxide and water may vary as a function of the density and size characteristics of the cells which one wishes to obtain.

In the definition of the quantity of expanding agents to be used, the type of extrusion apparatus with which the process according to the invention is carried out as well as the type of polystyrene to be subjected to extrusion play an important role.

The following considerations may be made on the matter:
within certain limits, an increase in the CO₂ percentage leads to a decrease in the density of the expanded polystyrene; beyond such a limit, however, an expanded polystyrene structure with many open cells is created, which allows the expanding agent to escape, and therefore the density increases.
a CO₂ percentage at the maximum limit of 5.5-6% based on the weight of the polystyrene permits to obtain cells with size in the range of 0.10-0.25 mm, as a function of the quantity of water. Beyond the aforesaid maximum limit, an expanded polystyrene structure is obtained, which comprises very small cells with size in the range of 0.001-0.05 mm. Such a structure is not generally desired, as the sheet obtained at the end of the process is too flexible.
an increase in the water percentage decreases the viscosity of the polymer melt and, acting as a solvent, allows to dissolve a greater quantity of CO₂, thus permitting to achieve particularly low densities before reaching the aforesaid limit, beyond which the cells break. CO₂ on its own, instead, does not considerably lower the viscosity of the melted plastic mass.
Water moreover provides a direct contribution to the expansion, and thus an increase in the water percentage leads to a decrease of the density.
Increasing the ratio between the water and the CO₂ percentages, there is generally an increase in the size of the cells.

Always with reference to FIG. 1, the invention will now be illustrated in greater detail by means of several not limiting embodiments of the process according to the invention.

### EXAMPLE 1

A mixture composed of:

68.25 kg of virgin polystyrene beads
30 kg of regenerated polystyrene beads
1.0 kg of flame retardant master batch
0.75 kg of coloring master batch
is continuously introduced into a loading hopper 3 of a primary extruder 1 of a plant 10 in the tandem configuration. Such plant 10 comprises, in addition to the primary extruder 1 (plasticizing cylinder) of 150 mm diameter, a secondary extruder 5 of 250 mm diameter.

The rotation speeds are set to 68 rpm for the primary extruder and 8.2 rpm for the secondary extruder with a resulting productivity of 730 kg/hour.

The aforesaid mixture is then plasticized and homogenized in the primary extruder 1, where it is heated to a temperature of 220° C.

A mixture of expanding agents 4 composed of 5.4 kg CO₂ and 0.65 kg water is continuously added to the plasticized and heated mixture (polymer melt).

The polymer melt including the above expanding agents is once again homogenized, then the melt incorporating CO₂ and water is pre-cooled, lowering the temperature of the final part of the primary extruder to 205° C.

At this point, the pre-cooled polymer melt 6, incorporating the expanding agents, is transferred into the secondary extruder 5, where it is further homogenously cooled to a temperature of 115° C.

The cooled polymer melt 7 is finally extruded through a die 8 having the shape of a horizontally arranged linear slit, with width of 300 mm and opening of 0.4 mm. Then it passes to a calibrator, at the exit of which a sheet is obtained, having a thickness of 40 mm.

The obtained sheet had a density of 30.2 kg/m³ and cells with average size of 0.2 mm uniformly distributed in the expanded polystyrene structure.

### EXAMPLE 2

A mixture composed of:

68.25 kg of virgin polystyrene beads
30 kg of regenerated polystyrene beads
1.0 kg of flame retardant master batch
0.75 kg of coloring master batch
is continuously introduced into a loading hopper 3 of a primary extruder 1 of a plant 10 in the tandem configuration.

Such plant 10 comprises, in addition to the primary extruder 1 (plasticizing cylinder) of 150 mm diameter, a secondary extruder 5 of 250 mm diameter. The rotation speeds are set to 70 rpm for the primary extruder and 8.9 rpm for the secondary extruder with a resulting productivity of 750 kg/hour.

The aforesaid mixture is therefore plasticized and homogenized in the primary extruder 1, where it is heated to a temperature of 220° C.

A mixture of expanding agents 4 composed of 5.5 kg of CO₂ and 0.7 kg of water is continuously added to the plasticized and heated mixture (polymer melt).

The polymer melt including the above expanding agents is once again homogenized, then the melt incorporating CO₂ and water is pre-cooled, lowering the temperature of the final part of the primary extruder to 200° C.

At this point, the pre-cooled polymer melt 6, incorporating the expanding agents, is transferred into the secondary extruder 5, where it is further homogenously cooled to a temperature of 110° C.

The cooled polymer melt 7 is finally extruded through a die 8, having the shape of a horizontally arranged linear slit, with width of 300 mm and opening of 0.4 mm. Then it passes to a calibrator, at the exit of which a sheet is obtained having a thickness of 50 mm.

The sheet obtained had a density of 29.2 kg/m³ and cells with average size of 0.22 mm uniformly distributed in the expanded polystyrene structure.

### EXAMPLE 3

A mixture composed of:

68.25 kg of virgin polystyrene beads
30 kg of regenerated polystyrene beads
1.0 kg of flame retardant master batch
0.75 kg of coloring master batch
is continuously introduced into a loading hopper 3 of a primary extruder 1 of a plant 10 in the tandem configuration.

Such plant 10 comprises, in addition to the primary extruder 1 (plasticizing cylinder) of 150 mm diameter, a secondary extruder 5 of 250 mm diameter. The rotation speeds are set to 64 rpm for the primary extruder and 7.8 rpm for the secondary extruder with a resulting productivity of 650 kg/hour.

The aforesaid mixture is then plasticized and homogenized in the primary extruder 1, where it is heated to a temperature of 215° C.

A mixture of expanding agents 4 composed of 5.6 kg of CO₂ and 0.65 kg of water is continuously added to the plasticized and heated mixture (polymer melt).

The polymer melt including such expanding agents is once again homogenized, then the melt incorporating CO₂ and water is pre-cooled, lowering the temperature of the final part of the primary extruder to 198° C.

At this point, the pre-cooled polymer melt 6, incorporating the expanding agents, is transferred into the secondary extruder 5, where it is further homogenously cooled to a temperature of 115° C.

The polymer melt 7 thus cooled is finally extruded through a die 8 having the shape of a horizontally arranged linear slit, with width of 300 mm and opening of 0.3 mm. Then it passes to a calibrator, at the exit of which a sheet is obtained, having a thickness of 30 mm.

The sheet obtained had a density of 31.5 kg/m³ and cells with average size of 0.22 mm uniformly distributed in the expanded polystyrene structure.

The main advantage of the process according to the present invention lies in that it is possible to produce sheets and panels of extruded expanded polystyrene having a particularly low density, by only using expanding agents with low environmental impact such as carbon dioxide and water.

Moreover, the use of such low-cost and easily found expanding agents also makes the process particularly advantageous from an economical standpoint.

A further advantage of the present process lies in that it can be carried out in industrial plants of considerable size, without decreasing the productive capacity of the plant and without sacrificing the quality of the extruded expanded polystyrene.

The expanded polystyrene was in fact always obtained with a density in the range of 28-40 kg/m³, and had uniform distribution and size of the cells of the porous structure.

Cells with dimensions equal to or lower than 0.25 mm, as obtained by means of the present process, are particularly desired in panels intended for heat insulation, since a diminution of the cell size is associated with a greater insulating power.

Once again, the present method was found to be of simple implementation; in particular, the metering of the expanding agents was found to be simple as well as consistent, and such agents can advantageously be simultaneously injected through the same injectors.

A person skilled in the art, in order to satisfy particular and contingent needs, can of course bring numerous modifications to the above described process according to the invention, without departing from the extent of protection of the invention as defined by the following claims.

1. A process for the production of extruded sheets of expanded polystyrene comprising the steps of:
a) heating polystyrene or a mixture composed of polystyrene and at least one component selected from the group consisting of flame retardants coloring agents, plasticizers, heat stabilizers and lubricants at a temperature in the range of 180-250° C. thus obtaining a polymer melt, which is subjected to homogenization;
b) adding to said polymer melt a mixture of expanding agents (4) comprising carbon dioxide and water; c) homogenizing said polymer melt including said expanding agents;
c) homogenizing said polymer melt including said expanding agents;
d) homogeneously cooling said polymer melt to a temperature lower than or equal to 140° C.;
e) extruding said cooled polymer melt through a die (8) to obtain an expanded polystyrene sheet;

2. A process according to claim 1, wherein said sheet is converted by means of a calibrator into a panel of a predetermined size and shape.

3. A process according to claim 1, wherein the quantity of carbon dioxide in said mixture of expanding agents (4) is in the range of 1-6% based on the weight of the polystyrene.

4. A process according to claim 1, wherein the quantity of water in said expanding agent mixture is in the range of 5-20% based on the weight of the carbon dioxide, preferably 7-14%.

5.-24. (canceled)

25. A process according to claim 3, wherein the quantity of water in said expanding agent mixture is in the range of 7-14% based on the weight of the carbon dioxide.

26. A process according to claim 1, wherein the quantity of water based on the weight of the polystyrene is in the range of 0.05-1%.

27. A process according to claim 3, wherein the quantity of water based on the weight of the polystyrene is in the range of 0.05-1%.

28. A process according to claim 1, wherein the quantity of water based on the weight of the polystyrene is in the range of 0.05-0.85%.

29. A process according to claim 3, wherein the quantity of water based on the weight of the polystyrene is in the range of 0.05-0.85%.

30. A process according to claim 1, wherein said extruded expanded polystyrene has a density in the range of 28-40 kg/m³.

31. A process according to claim 2, wherein said extruded expanded polystyrene has a density in the range of 28-40 kg/m³.

32. A process according to claim 1, wherein said extruded expanded polystyrene comprises cells with size lower than or equal to 0.25 mm.

33. A process according to claim 30, wherein said extruded expanded polystyrene comprises cells with size lower than or equal to 0.25 mm.

34. A process according to claim 1, wherein said polymer melt incorporating the expanding agents is pre-cooled in said plasticizing cylinder (1) to a temperature in the range of 190-210° C., before being transferred into said extrusion cylinder (5).

35. A process according to claim 1, wherein said polystyrene includes virgin polystyrene beads and regenerated polystyrene beads.
